(19) United States
(12) Patent Application Publication
(10) Pub. No.: US 2010/0154748 A1
(43) Pub. Date: Jun. 24, 2010

(54) ENGINE BLOCK AND CYLINDER HEAD ASSEMBLY FOR A VARIABLE COMPRESSION RATIO ENGINE

(76) Inventor: Vianney Rabhi, Lyon (FR)

Correspondence Address: YOUNG & THOMPSON, 209 Madison Street, Suite 500, Alexandria, VA, 22314, US

(21) Appl. No.: 12/160,430

(22) PCT Filed: Jan. 26, 2007
(86) PCT No.: PCT/FR2007/000150

§ 371 Date: Jul. 10, 2008

Related U.S. Application Data
(60) Provisional application No. 60/762,896, filed on Jan. 30, 2006.

(30) Foreign Application Priority Data
Jan. 26, 2006 (FR) 06 00707

(51) Int. Cl. F02B 75/04; F01M 1/02

(52) U.S. Cl. 123/48 C; 123/196 R

(57) ABSTRACT

An engine block and cylinder head assembly for a variable compression ratio engine, includes a common cylinder head (300) which co-operates with a cylinder case (100) in order to close (i) the end of at least one cylinder (110) of the engine at the combustion chamber (302) thereof and (ii) the end of at least one cylinder (112) of a control jack (8) of the engine at the upper chamber (121) of the jack, the cylinder case containing all of the components of the mobile coupling system (2, 3, 4, 5, 6, 7, 9, 10, 13) of the variable compression ratio engine.

The present invention relates to a cylinder head and engine block assembly for an engine with a variable volumetric ratio of which the cylinder head is common to the combustion chamber and to the control jacks.

International Patents WO 98/51911, WO 00/31377, WO 03/008783, which belong to the Applicant, disclose various mechanical devices for a variable volumetric ratio engine.

It will be seen that International Patent WO 98/51911, in the name of the Applicant, describes a device serving to improve the overall efficiency of internal combustion piston engines used at variable load and speed by adapting their effective displacement and/or their volumetric ratio during operation.

It will be observed from International Patents WO 00/31377 and WO 03/008783, in the name of the Applicant, that the mechanical transmission device for a variable volumetric ratio engine comprises at least one cylinder in which there moves a piston which is secured, in its lower portion, to a transmission member cooperating, on the one hand, by means of one small-sized rack, with a rolling guide device and, on the other hand, by means of another large-sized rack, with a toothed wheel secured to a connecting rod, this making it possible to transmit the movement between said piston and said connecting rod.

The mechanical transmission device for a variable volumetric ratio engine also comprises at least one control rack cooperating with the toothed wheel, means for fastening the piston to the transmission member that provide a clamping preload, connection means which make it possible to stiffen the teeth of the racks, and means of reinforcing and lightening the structure of the toothed wheel.

It will be noted that the cylinder block is capped by two separate cylinder heads: one, of a type known per se, includes valves and their actuating system and closes the upper end of the cylinder of the variable volumetric ratio engine, and the other, specific to said engine, serves to close the upper end of the control jack of said engine.

It will be observed that this arrangement requires the provision of two separate joint planes situated at different heights for each of the two cylinder heads, a factor which considerably complicates the production of the engine by comparison with more conventional engines having only one joint plane.

It will also be seen that the fastening of the cylinder head of the control jack requires bolts whose number and strength is at least equivalent to that required for the bolts of the cylinder head of the engine, since the total force assumed by said bolts of the cylinder head of the control jack is comparable to that assumed by the bolts of the cylinder head of the engine.

It will also be noted that the overall size of the control jack cylinder head is such that it is difficult to house the bolts which fasten said control jack cylinder head to the cylinder block. Specifically, the control jack cylinder head is placed relatively low with respect to the cylinder block and the length of said bolts is small, thereby reducing their fatigue strength by increasing the amplitude of the repeated stress to which they are subjected.

Another problem arises from the small distance between the cylinder head of the engine and the cylinder head of the control jack, which makes it difficult to form ducts of suitable cross section within the casting of the cylinder block that allow the return of lubricating oil from the cylinder head of the engine toward the lubricating oil sump of said engine, on the one hand, and that allow blow-by gasses to rise from said cylinder block toward the cylinder head on the other hand.

Finally, given the limited vertical space available for housing the control jack cylinder head between the control jack or jacks and the intake or exhaust system of the engine, it is difficult to provide said jack cylinder head with sufficient stiffness to withstand the pressure forces to which it is subjected, and to house above said cylinder head the linkage which is used control the vertical position of the control rods of the engine.

With the aim of significantly reducing the complexity of producing the variable volumetric ratio engine, the cylinder head and engine block assembly according to the invention is distinguished from the prior art in that, according to one specific embodiment:
The production of the cylinder head/engine block assembly is simplified, thereby reducing its manufacturing cost.
The stiffness of the cylinder head/engine block assembly is improved.
The number of bolts required to close the upper end of the cylinder of the variable volumetric ratio engine and the upper end of the control jack of said engine is reduced.
The average length of the fastening bolts of the control jack cylinder head is increased and their fatigue strength is improved.
The formation in the cylinder block of blow-by ducts and ducts for the downward return of oil is facilitated.

The cylinder head and engine block assembly according to the present invention for an engine with a variable volumetric ratio comprises a common cylinder head which cooperates with a cylinder block in order, on the one hand, to close the end of at least one cylinder of the engine in the region of its combustion chamber and, on the other hand, to close the end of at least one cylinder of a control jack of said engine in the region of the upper chamber of said jack, said cylinder block containing all the components of the coupled moving system of the variable volumetric ratio engine.

The cylinder head and engine block assembly according to the present invention comprises a common cylinder head including one and the same joint plane which cooperates with one and the same joint plane belonging to the cylinder block, said joint planes cooperating with at least one gasket which makes it possible to provide sealing between said common cylinder head and said cylinder block.

The cylinder head and engine block assembly according to the present invention comprises a common cylinder head including at least one combustion chamber, at least one ignition device and at least two valves and their device which opens them and closes them.

The cylinder head and engine block assembly according to the present invention comprises a common cylinder head which includes a chamber formed at the end of the upper rod of the control jack or jacks of the engine, said chamber being connected to a pressurized oil inlet.

The cylinder head and engine block assembly according to the present invention comprises a common cylinder head which includes a chamber formed at the end of the control rod of the control jack or jacks of the engine, said chamber being connected to a pressurized oil inlet.

The cylinder head and engine block assembly according to the present invention comprises a chamber formed at the end of the control rod containing a spring which exerts a thrust on the control rod while bearing on the bottom of said chamber on the one hand and on the end of said control rod on the other hand.

The cylinder head and engine block assembly according to the present invention comprises a common cylinder head including passages formed within its mass which interconnect the chambers formed at the end of the upper rods of the control jacks.

The cylinder head and engine block assembly according to the present invention comprises a common cylinder head including passages formed within its mass which interconnect the chambers formed at the end of the control rods of the control jacks.

The cylinder head and engine block assembly according to the present invention comprises a common cylinder head including passages formed within its mass which connect the chamber or chambers formed at the end of the upper rod of the control jack or jacks to the chamber or chambers formed at the end of the control rod of said control jack or jacks.

The cylinder head and engine block assembly according to the present invention comprises a common cylinder head which includes means for fastening the peripheral members required for the operation of the engine and the vehicle on the one hand, and for fastening the engine to the vehicle on the other hand.

The cylinder head and engine block assembly according to the present invention comprises a cylinder block including one and the same joint plane which cooperates with a joint plane belonging to the common cylinder head, said joint planes making it possible to provide sealing between said common cylinder head and said cylinder block in the region of the combustion chamber or chambers of the engine on the one hand, and in the region of the upper chamber of the control jack or jacks on the other hand.

The cylinder head and engine block assembly according to the present invention comprises a cylinder block which includes a control camshaft placed below the control jack or jacks of the engine and above the control rack or racks of said engine, the control rod or rods of said engine coming to bear on said camshaft.

The cylinder head and engine block assembly according to the present invention comprises a control camshaft which is housed in bearings in which it can turn.

The cylinder head and engine block assembly according to the present invention comprises at least one bearing in which the control camshaft turns, the radius of which bearing is greater than the largest radius of the cams of said camshaft.

The cylinder head and engine block assembly according to the present invention comprises bearings in which the control camshaft turns, these bearings having different diameters in order to facilitate the mounting of said camshaft.

The cylinder head and engine block assembly according to the present invention comprises a control camshaft which includes a rotational return spring.

The cylinder head and engine block assembly according to the present invention comprises a control camshaft which includes transmission means enabling it to be coupled to an electric motor capable of rotating it.

The cylinder head and engine block assembly according to the present invention comprises a cylinder block including at least one rocker which imposes a vertical position on the control rod according to the angular position of the camshaft, and at the end of which rocker said control rod comes to bear, said rod being kept in contact with said end of the rocker by the spring housed in the chamber formed at the end of said rod and/or by the hydraulic pressure existing in said chamber.

The cylinder head and engine block assembly according to the present invention comprises a rocker which bears on the cylinder block on the one hand and on one of the cams of the camshaft on the other hand.

The cylinder head and engine block assembly according to the present invention comprises a rocker which bears on the cylinder block by way of a connection whose vertical position with respect to the cylinder block can be adjusted by means of an adjusting device.

The cylinder head and engine block assembly according to the present invention comprises an adjusting device, which makes it possible to adjust the vertical position of the connection between the rocker and the cylinder block and which consists of a support bolted into said cylinder block which is locked in rotation by a locking means.

The cylinder head and engine block assembly according to the present invention comprises a cylinder block which includes stops which fix the limits of the top position and the bottom position of the control rack and which cooperate with stops secured to said control rack.

The cylinder head and engine block assembly according to the present invention comprises a common cylinder head which includes a stop which fixes the limit of the top position of the control rack and which cooperates with a stop secured to said control rack.

The cylinder head and engine block assembly according to the present invention comprises stops which fix the limits of the top position and the bottom position of the control rack and which consist, on said control rack side, of a flexible material which covers the upper and lower faces of the control jack piston secured to said rack, said flexible material being able to come into contact either with the common cylinder head, thus fixing the limit of the top position of the control rack, or with the cylinder block, thus fixing the limit of the bottom position of the control rack.

The cylinder head and engine block assembly according to the present invention comprises a cylinder block which includes at least one rectangular aperture closed off by a rectangular plate which is fastened to the cylinder block by bolts and which constitutes the supports for a rolling device of the engine.

The cylinder head and engine block assembly according to the present invention comprises a cylinder block which includes means for fastening the peripheral members required for the operation of the engine and the vehicle on the one hand, and for fastening the engine to the vehicle on the other hand.

The cylinder head and engine block assembly according to the present invention comprises one and the same gasket for providing sealing between the common cylinder head and the cylinder block in the region of the combustion chamber or chambers on the one hand, and in the region of the upper chamber of the control jack or jacks on the other hand.

The cylinder head and engine block assembly according to the present invention comprises at least one passage which traverses the gasket placed between the common cylinder head and the cylinder block and through which pressurized engine lubricating oil can flow between the cylinder block and the common cylinder head.

The cylinder head and engine block assembly according to the present invention comprises at least one passage which traverses the gasket placed between the common cylinder head and the cylinder block and which allows the oil, once it has lubricated the mechanical parts of the common cylinder head, to return back down into the cylinder block under gravity.

The cylinder head and engine block assembly according to the present invention comprises at least one passage which traverses the gasket placed between the common cylinder head and the cylinder block and which allows the blow-by gasses present in the cylinder block to rise toward the common cylinder head.

The cylinder head and engine block assembly according to the present invention comprises at least one passage which traverses the gasket placed between the common cylinder head and the cylinder block and which allows the coolant to circulate between the water chambers of the cylinder block and the water chambers of the common cylinder head.

The description below with reference to the appended drawings, which are given by way of non-limiting examples, will allow a better understanding of the invention, the features that it displays and the advantages that it is able to offer:

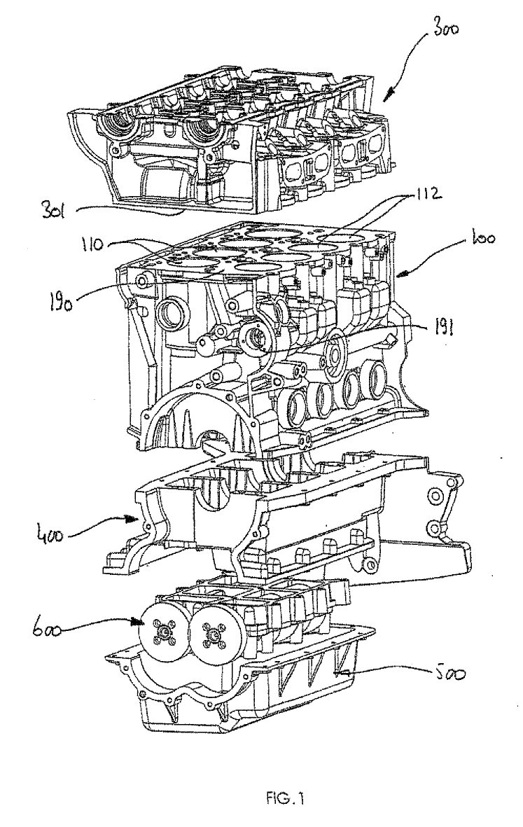

FIG. 1 is an exploded perspective view illustrating the cylinder head and engine block assembly for a variable volumetric ratio engine according to the present invention.

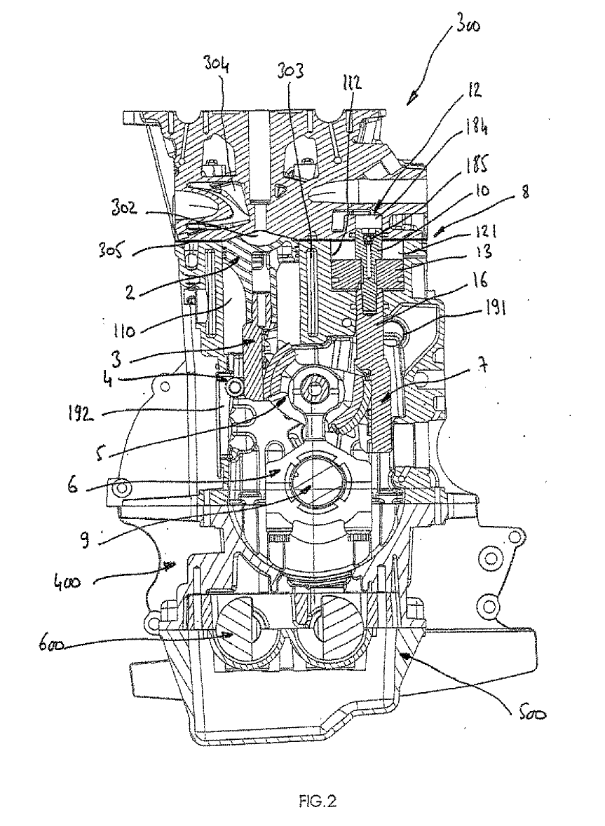

FIG. 2 is a sectional view showing the cylinder head and engine block assembly for a variable volumetric ratio engine according to the present invention.

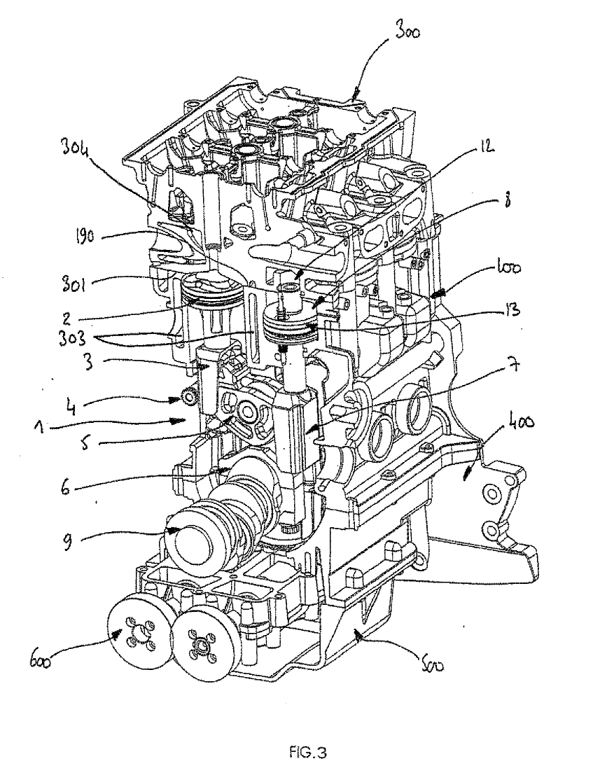

FIG. 3 is a perspective view representing at least one cylinder of the cylinder head and engine block assembly for a variable volumetric ratio engine according to the present invention.

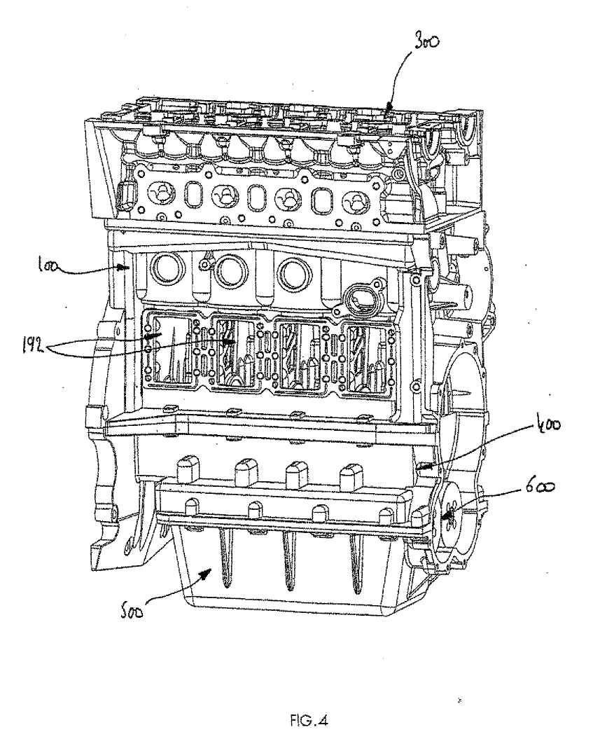

FIG. 4 is a perspective side view showing the cylinder head and engine block assembly for a variable volumetric ratio engine according to the present invention.

FIG. 5 is a sectional view illustrating the control device for a variable volumetric ratio engine according to the present invention.

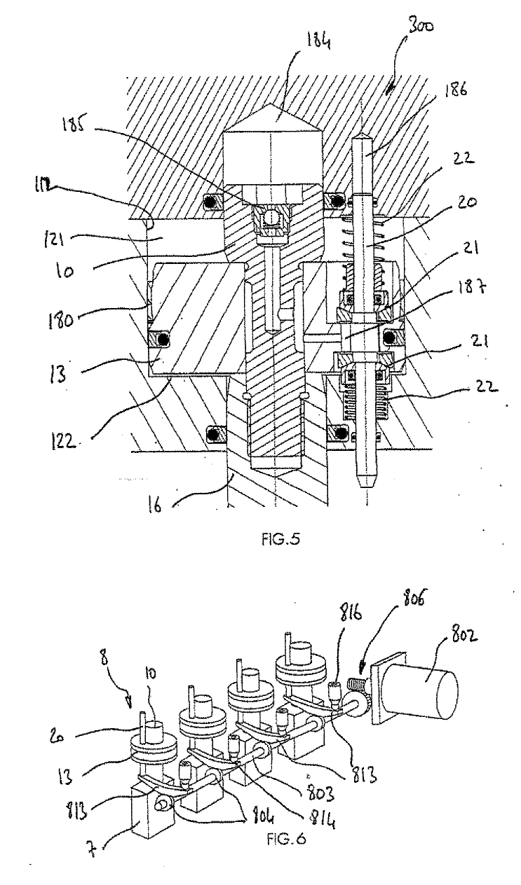

FIG. 6 is a schematic view representing the electromechanical device which the cylinder head and engine block assembly according to the present invention may include and which makes it possible to control the compression ratio of a variable volumetric ratio engine.

FIGS. 1 to 4 show a cylinder head and engine block assembly for a variable volumetric ratio engine of which the cylinder head 300 is common to the combustion chamber and to the control jacks 8.

The variable volumetric ratio engine comprises for each cylinder a transmission device 1 and a piston 2.

The mechanical transmission device 1 includes, in the lower portion of the piston 2, a transmission member 3 secured to said piston and cooperating, on the one hand, with a rolling guide device 4 and, on the other hand, with a toothed wheel 5.

The toothed wheel 5 cooperates with a connecting rod 6 connected to a crankshaft 9 in order to transmit the movement between the piston 2 and said crankshaft 9.

On the opposite side to the transmission member 3, the toothed wheel 5 cooperates with another rack, termed control rack 7, whose vertical position with respect to the engine block is controlled by a control device 12.

The cylinder head and engine block assembly comprises a common cylinder head 300 which cooperates with a cylinder block 100 in order, on the one hand, to close the end of at least one cylinder 110 of the engine and, on the other hand, to close the end of at least one cylinder 112 of a control jack 8 of a control device 12 of said engine.

The cylinder block 100 contains all the components of the coupled moving system of the variable volumetric ratio engine.

The cylinder head and engine block assembly also comprises, beneath the cylinder block 100, a bearing housing 400 and an oil sump 500. The cylinder head and engine block assembly can also include balancing shafts 600 rotated by the crankshaft 9 by way of a toothed belt, a chain or a train of pinions.

The common cylinder head 300, the cylinder block 100, the bearing housing 400 and the oil sump 500 can be made of cast iron or of light aluminum or magnesium alloy.

The common cylinder head 300 includes one and the same joint plane 301 which cooperates with one and the same joint plane 190 belonging to the cylinder block 100.

The common cylinder head 300 includes at least one combustion chamber 302, at least one ignition device and at least two valves and their device which opens them and closes them.

The common cylinder head 300 and the cylinder block 100 respectively include means for fastening the peripheral members required for the operation of the engine and the vehicle on the one hand, and for fastening the engine to the vehicle on the other hand.

Each joint plane 190, 301 cooperates with at least one gasket 305 which makes it possible to provide sealing between the common cylinder head 300 and the cylinder block 100 in the region of the combustion chamber or chambers 302 of the engine on the one hand, and in the region of the upper chamber 121 of the control jack or jacks 8 on the other hand.

The sealing between the common cylinder head 300 and the cylinder block 100 is provided by one and the same gasket 305 in the region of the combustion chamber or chambers 302 on the one hand, and in the region of the upper chamber 121 of the control jack or jacks 8 on the other hand.

The gasket 305 can consist of a sheet of graphite-impregnated asbestos or of a carbon-based sheet which can be mounted between two copper, aluminum or steel sheets. The gasket 305 can include reinforcing means in the region of the edge of the cylinders which consist of a metal band.

According to another embodiment, the gasket 305 can consist of a ribbed metal sheet mounted with a sealing product, and can comprise or cooperate with one or more O-ring seals.

The gasket 305 common to the common cylinder head 300 and to the cylinder block 100 is traversed by at least one passage through which pressurized engine lubricating oil can flow between said cylinder block and said common cylinder head.

The gasket 305 common to the common cylinder head 300 and to the cylinder block 100 is traversed by at least one passage which allows the oil, once it has lubricated the mechanical parts of the common cylinder head 300, to return back down into the cylinder block 100 under gravity.

The gasket 305 common to the common cylinder head 300 and to the cylinder block 100 is traversed by at least one passage which allows the blow-by gasses present in the cylinder block 100 to rise toward the common cylinder head 300.

The gasket 305 common to the common cylinder head 300 and to the cylinder block 100 is traversed by at least one passage which allows engine coolant to circulate between the water chambers 303 of the cylinder block 100 and the water chambers 304 of the common cylinder head 300.

The cylinder block 100 includes at least one rectangular aperture 192 closed off by a rectangular plate (not shown) which is fastened to the cylinder block 100 by bolts and which forms a support for the raceway and the small-sized racks of the rolling guide device 4 of the engine.

FIG. 5 shows the control device 12 of the variable volumetric ratio engine including a control jack 8 which consists of an upper jack rod 10, of a lower jack rod 16, of a jack piston 13 and of a control rod 20.

The jack piston 13 includes a peripheral swivel ring 180 which matches the spherical shape of said jack piston.

In its internal portion and at its center, the upper jack rod 10 includes a nonreturn valve 185 which compensates for leaks, the inlet of which valve is in communication with a chamber 104 made in the common cylinder head 300.

The outlet of the nonreturn valve 185 is connected by a duct 187 made in the jack piston 13 of the control jack 8 and allowing the control rod 20 to pass through said piston.

The duct 187 communicates in the region of the control rod 20, by way of valves 21 maintained on their seat by a spring 22, either with an upper chamber 121 or with a lower chamber 122 of the control jack 8 which are respectively situated above and below the jack piston 13.

The common cylinder head 300 includes at least one first chamber 184 formed at the end of the upper rod 10 of the control jack or jacks 8 of the engine, said chamber 184 being connected to a pressurized oil inlet.

The common cylinder head 300 includes at least one second chamber 186 formed at the end of the control rod 20 of the control jack or jacks 8 of the engine, said chamber 186 being connected to a pressurized oil inlet.

The second chamber 186, formed at the end of the control rod 20, contains a spring (not shown) which exerts a thrust on said control rod while bearing on the bottom of said chamber on the one hand and on the end of said control rod on the other hand.

The common cylinder head 300 can include passages formed within its mass which interconnect the first chambers 184 formed at the end of the upper rods 10 of the control jack or jacks 8.

Likewise, the common cylinder head 300 can include passages formed within its mass which interconnect the second cambers 186 formed at the end of the control rods 20 of the control jacks 8.

By way of non-limiting example, the common cylinder head 300 can include passages (not shown) which connect the chamber or chambers 184 formed at the end of the upper rod 10 of the control jack or jacks 8 to the chamber or chambers 186 formed at the end of the control rod 20 of said control jack or jacks 8.

FIG. 6 represents a control camshaft 803 belonging to the cylinder block 100, this camshaft being placed below the control jack or jacks 8 of the engine and above the control rack or racks 7 of said engine and the control rod or rods 20 of said engine bearing thereon.

According to one specific embodiment, the control camshaft 803 can turn in bearings 191 or in ball bearings or roller bearings.

The cylinder block 100 comprises at least one bearing 191 in which the control camshaft 803 turns, the radius of said bearing being greater than the largest radius of the cams 804 of said camshaft.

The cylinder block 100 comprises bearings 191 in which the control camshaft 803 turns and which have different diameters in order to facilitate the mounting of said camshaft.

The cylinder block 100 comprises a control camshaft 803 which includes a rotational return spring (not shown).

The cylinder block 10 comprises a control camshaft 803 which includes intermediate transmission means 806 enabling it to be coupled to an electric motor 802 capable of rotating said camshaft.

The cylinder block 100 comprises at least one rocker 813 which imposes a vertical position on the control rod 20 according to the angular position of the camshaft 803, and at the end of which rocker said control rod 20 comes to bear.

The control rod 20 is kept in contact with the end of the rocker 813 by a spring (not shown) housed in the chamber 186 formed at the end of said rod and/or by the hydraulic pressure existing in said chamber.

The cylinder block 100 comprises a rocker 813 which bears on the cylinder block 100 on the one hand and on one of the cams 804 of the control camshaft 803 on the other hand.

The rocker 813 bears on the cylinder block 100 by way of a connection or an articulation 814 whose vertical position with respect to the cylinder block 100 can be fixed by means of an adjusting device 816. The connection 814 between the rocker 813 and the cylinder block 100 can consist of a ball joint or of a pivot connection.

The cylinder block 100 comprises an adjusting device 816 which makes it possible to fix the vertical position of the connection 814 between the rocker 813 and the cylinder block 100.

The adjusting device 816 consists of a support bolted into the cylinder block 100 which is locked in rotation by a locking means which can be, for example, a locknut, adhesive, a wedge or a “Nylstop”-type nut.

The cylinder block 100 includes stops (not shown) which fix the limits of the top position and the bottom position of the control rack 7. In this case, the stops of the cylinder block 100 cooperate with other stops secured to the control rack 7.

The common cylinder head 300 includes a stop which fixes the limit of the top position of the control rack 7. In this case, the stop of the common cylinder head 300 cooperates with a stop secured to the control rack 7.

The stops which fix the limits of the top position and the bottom position of the control rack 7 consist, on said control rack side, of a flexible material which covers the upper and lower faces of the jack piston 13 of the control jack 8 secured to said rack.

The stops made of flexible material can come into contact either with the common cylinder head 300, thus fixing the limit of the top position of the control rack 7, or with the cylinder block 100, thus fixing the limit of the bottom position of the control rack 7.

It should moreover be understood that the foregoing description has been given purely by way of example and that it in no way limits the scope of the invention from which there would be no departure if the implementation details described were replaced by any other equivalent.

1. A cylinder head and engine block assembly for an engine with a variable volumetric ratio, characterized in that it comprises a common cylinder head (300) which cooperates with a cylinder block (100) in order, on the one hand, to close the end of at least one cylinder (110) of the engine in the region of its combustion chamber (302) and, on the other hand, to close the end of at least one cylinder (112) of a control jack (8) of said engine in the region of the upper chamber (121) of said jack, said cylinder block containing all the components of the coupled moving system (2,3,4,5,6,7,9,10,13) of the variable volumetric ratio engine.

2. The cylinder head and engine block assembly as claimed in claim 1, characterized in that the common cylinder head (300) includes one and the same joint plane (301) which cooperates with one and the same joint plane (190) belonging to the cylinder block (100), said joint planes cooperating with at least one gasket (305) which allows sealing to be provided between said common cylinder head (300) and said cylinder block (100).

3. The cylinder head and engine block assembly as claimed in claim 1, characterized in that the common cylinder head (300) includes at least one combustion chamber (302), at least one ignition device and at least two valves and their device which opens them and closes them.

4. The cylinder head and engine block assembly as claimed in claim 1, characterized in that the common cylinder head (300) includes a first chamber (184) formed at the end of the upper rod (10) of the control jack or jacks (8) of the engine, said chamber (184) being connected to a pressurized oil inlet.

5. The cylinder head and engine block assembly as claimed in claim 4, characterized in that the common cylinder head (300) includes a second chamber (186) formed at the end of the control rod (20) of the control jack or jacks (8) of the engine, said chamber being connected to a pressurized oil inlet.

6. The cylinder head and engine block assembly as claimed in claim 5, characterized in that the second chamber (186) formed at the end of the control rod (20) contains a spring which exerts a thrust on the control rod (20) while bearing on the bottom of said chamber on the one hand and on the end of said control rod on the other hand.

7. The cylinder head and engine block assembly as claimed in claim 4, characterized in that the common cylinder head (300) includes passages formed within its mass which interconnect the first chambers (184) formed at the end of the upper rod (10) of each control jack (8).

8. The cylinder head and engine block assembly as claimed in claim 5, characterized in that the common cylinder head (300) includes passages formed within its mass which interconnect the second chambers (186) formed at the end of the control rods (20) of each control jack (8).

9. The cylinder head and engine block assembly as claimed in claim 5, characterized in that the common cylinder head (300) includes passages formed within its mass which connect the first chamber or chambers (184) formed at the end of the upper rod (10) of each control jack (8) to the second chamber or chambers (186) formed at the end of the control rods (20) of each control jack (8).

10. The cylinder head and engine block assembly as claimed in claim 1, characterized in that the common cylinder head (300) includes means for fastening the peripheral members required for the operation of the engine and the vehicle on the one hand, and for fastening the engine to the vehicle on the other hand.

11. The cylinder head and engine block assembly as claimed in claim 1, characterized in that the cylinder block (100) includes a control camshaft (803) placed below the control jack or jacks (8) of the engine and above one or more control racks (7) of said engine, the control rod or rods (20) of said engine coming to bear on said camshaft.

12. The cylinder head and engine block assembly as claimed in claim 11, characterized in that the control camshaft (803) is housed in bearings (191) in which it can turn.

13. The cylinder head and engine block assembly as claimed in claim 12, characterized in that the radius of at least one bearing (191) in which the control camshaft (803) turns is greater than the largest radius of the cams (804) of said camshaft.

14. The cylinder head and engine block assembly as claimed in claim 12, characterized in that the bearings (191) in which the control camshaft (803) turns have different diameters in order to facilitate the mounting of said camshaft.

15. The cylinder head and engine block assembly as claimed in claim 11, characterized in that the control camshaft (803) includes a rotational return spring (805).

16. The cylinder head and engine block assembly as claimed in claim 11, characterized in that the control camshaft (803) includes intermediate transmission means (806) which enable it to be coupled to an electric motor (802) capable of rotating said camshaft.

17. The cylinder head and engine block assembly as claimed in claim 11, characterized in that the cylinder block (100) includes at least one rocker (813) which imposes a vertical position on the control rod (20) according to the angular position of the camshaft (803), and at the end of which rocker said control rod (20) comes to bear, said rod being kept in contact with said end of the rocker (803) by a spring housed in a chamber (186) formed at the end of said rod and/or by the hydraulic pressure existing in said chamber.

18. The cylinder head and engine block assembly as claimed in claim 17, characterized in that the rocker (813) bears on the cylinder block (100) on the one hand and on one of the cams (804) of the camshaft (803) on the other hand.

19. The cylinder head and engine block assembly as claimed in claim 18, characterized in that the rocker (813) bears on the cylinder block (100) by way of a connection (814) whose vertical position with respect to the cylinder block (100) can be adjusted by means of an adjusting device (816).

20. The cylinder head and engine block assembly as claimed in claim 19, characterized in that the adjusting device (816), which makes it possible to adjust the vertical position of the connection between the rocker and the cylinder block (100), consists of a support bolted into said cylinder block which is locked in rotation by a locking means.

21. The cylinder head and engine block assembly as claimed in claim 1, characterized in that the cylinder block (100) includes stops which fix the limits of the top position and the bottom position of the control rack (7) and which cooperate with stops secured to said control rack.

22. The cylinder head and engine block assembly as claimed in claim 1, characterized in that the common cylinder head (300) includes a stop which fixes the limit of the top position of the control rack (7) and which cooperates with a stop secured to said control rack.

23. The cylinder head and engine block assembly as claimed in claim 1, characterized in that the stops fixing the limits of the top position and the bottom position of the control rack (7) consist, on said control rack side, of a flexible material which covers the upper and lower faces of the control jack piston (13) secured to said rack, said flexible material being able to come into contact either with the common cylinder head (300), thus fixing the limit of the top position of the control rack (7), or with the cylinder block (100), thus fixing the limit of the bottom position of said rack.

24. The cylinder head and engine block assembly as claimed in claim 2, characterized in that the cylinder block (100) includes at least one rectangular aperture (192) closed off by a rectangular plate which is fastened to the cylinder block by means of bolts and which constitutes the support for a rolling device (4) of the engine.

25. The cylinder head and engine block assembly as claimed in claim 1, characterized in that the cylinder block (100) includes means for fastening the peripheral members required for the operation of the engine and the vehicle on the one hand, and for fastening the engine to the vehicle on the other hand.

26. The cylinder head and engine block assembly as claimed in claim 2, characterized in that the gasket (305) placed between the common cylinder head (300) and the cylinder block (100) is traversed by at least one passage through which the pressurized engine lubricating oil can flow between said cylinder block and said common cylinder head.

27. The cylinder head and engine block assembly as claimed in claim 2, characterized in that the gasket (305) placed between the common cylinder head (300) and the cylinder block (100) is traversed by at least one passage which allows the oil, once it has lubricated the mechanical parts of the common cylinder head (300), to return back down into the cylinder block (100) under gravity.

28. The cylinder head and engine block assembly as claimed in claim 2, characterized in that the gasket (305) placed between the common cylinder head (300) and the cylinder block (100) is traversed by at least one passage which allows the blow-by gasses present in the cylinder block (100) to rise toward the common cylinder head (300).

29. The cylinder head and engine block assembly as claimed in claim 2, characterized in that the gasket (305) placed between the common cylinder head (300) and the cylinder block (100) is traversed by at least one passage which allows the engine coolant to circulate between the water chambers (303) of the cylinder block (100) and the water chambers (304) of the common cylinder head (300).
